(19) United States
(12) Patent Application Publication
(10) Pub. No.: US 2006/0174014 A1
(43) Pub. Date: Aug. 3, 2006

(54) System and method for transmitting/receiving alerting information for mobile terminal in a wireless communication system

(75) Inventor: Su-Jin Bae, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/341,864

(22) Filed: Jan. 30, 2006

(30) Foreign Application Priority Data
Jan. 31, 2005 (JP) 2005-8788

(51) Int. Cl. G06F 15/16

(52) U.S. Cl. 709/227

(57) ABSTRACT

A system is provided for transmitting/receiving alerting information in a wireless communication system. A calling mobile terminal (MT) encodes a session initiate protocol (SIP) invite message comprising multimedia alerting information and transmitting the encoded SIP invite message. An Internet protocol multimedia subsystem (IMS) server receives the SIP invite message from the calling MT, and transmits the SIP invite message to the called MT according to service profile of the calling MT and the called MT. The called MT decodes encoded multimedia alerting information in the received SIP invite message and message and plays back the multimedia alerting information.

### PRIORITY

This application claims the benefit under 35 U.S.C. § 119(a) of Korean Patent Application entitled “System and Method for Transmitting Alerting of Mobile Terminal in a Wireless Communication System” filed in the Korean Intellectual Property Office on Jan. 31, 2005 and assigned Serial No. 2005-8788, the entire disclosure of which is hereby incorporated by reference.

### BACKGROUND OF THE INVENTION

1. Field of the Invention

The present invention relates generally to a system and method for transmitting/receiving alerting information for a mobile terminal in a wireless communication system. More particularly, the present invention relates to a system and method for transmitting/receiving alerting information for a called mobile terminal in a wireless terminal.

2. Description of the Related Art

Wireless communication systems have been developed to allow users to perform communication without being restricted to a particular place or a wired line. A mobile communication system is a typical wireless communication system, which has been developed for the purpose of providing a voice service to users. The mobile communication system has evolved into an advanced system that can provide high-speed data service as well as currently available voice service and simple data service.

The voice service provides a real-time service through a circuit switched network such as a Public Switched Telephone Network (PSTN). A packet service provides a service through a network capable of packet transmission, such as an Internet protocol (IP) network. In this network environment, when a calling mobile terminal (MT) sends a call request to set up a call with a called MT, alerting information is provided to the called MT. The alerting information can then be provided to the user through any one of or a combination of bell, vibration and light (silence) indications previously set in the called MT. Bell sounds for the bell indication may include basic bell sounds set in an MT manufacturing process or user bell sounds downloaded through the Internet.

Conventionally, however, the alerting information is provided to a recipient (or called user) through any one of or a combination of the bell, vibration and silence indications (or alerts) previously set in the called MT by the recipient. Therefore, it is not possible to provide the recipient with the alerting information based on intention, preference and taste of a sender (or calling user).

Accordingly, there is a need for an improved system and method for providing a recipient with alerting information based on intention, preference and taste of a sender in a mobile terminal of a wireless communication system.

### SUMMARY OF THE INVENTION

An aspect of embodiments of the present invention is to address at least the above problems and/or disadvantages and to provide at least the advantages described below. Accordingly, an aspect of embodiments of the present invention is to provide a system and method for transmitting alerting information based on intention, preference and taste of a sender to a called MT.

It is another object of the present invention to provide a system and method for transmitting, to a called MT, various multimedia alerting information such as voice, picture, moving image and text information, based on intention, preference and taste of a sender.

According to one aspect of an exemplary embodiment of the present invention, there is provided a system for transmitting/receiving alerting information in a wireless communication system including a mobile terminal (MT), a base station (BS) connected to the MT through a wireless channel, and a packet data service node (PDSN) that provides a packet data service to the MT via the BS. The system comprises a calling MT for encoding a session initiate protocol (SIP) invite message including multimedia alerting information and transmitting the encoded SIP invite message. An Internet protocol multimedia subsystem (IMS) server receives the SIP invite message from the calling MT, and transmits the SIP invite message to a called MT according to service profiles of the calling MT and the called MT. The called MT decodes encoded multimedia alerting information in the received SIP invite message and plays back the multimedia alerting information.

According to another aspect of an exemplary embodiment of the present invention, there is provided a system for transmitting/receiving alerting information in a wireless communication system including a mobile terminal (MT), a base station (BS) connected to the MT through a wireless channel, and a packet data service node (PDSN) that provides a packet data service to the MT via the BS. The system comprises a calling MT for encoding a session initiate protocol (SIP) invite message including multimedia alerting information and transmitting the encoded SIP invite message. An Internet protocol multimedia subsystem (IMS) server receives the SIP invite message from the calling MT, searches service profiles of the calling MT and a called MT, and transmits the SIP invite message to the called MT according to the search result to set up a call between the calling MT and the called MT. A multimedia alerting application server maps previously stored multimedia information and its uniform resource locator (URL) to a header of the SIP invite message in association with the IMS server, and uploads the multimedia information to the called MT. The called MT downloads multimedia information included in the SIP invite message from the multimedia alerting application server, and plays back the downloaded multimedia information.

According to a further aspect of an exemplary embodiment of the present invention, there is provided an apparatus for transmitting/receiving alerting information in a wireless communication system including a mobile terminal (MT), a base station (BS) connected to the MT through a wireless channel, and a packet data service node (PDSN) that provides a packet data service to the MT via the BS. The apparatus comprises a calling MT for encoding a session initiate protocol (SIP) invite message including multimedia alerting information and transmitting the encoded SIP invite message. A called MT receives the SIP invite message from an Internet protocol multimedia subsystem (IMS) server that receives the SIP invite message from the calling MT and transmits the SIP invite message to the called MT according to service profiles of the calling MT and the called MT, decodes encoded multimedia alerting information included in the received SIP invite message, and plays back the multimedia alerting information.

According to yet another aspect of an exemplary embodiment of the present invention, there is provided an apparatus for transmitting/receiving alerting information in a wireless communication system including a mobile terminal (MT), a base station (BS) connected to the MT through a wireless channel, and a packet data service node (PDSN) that provides a packet data service to the MT via the BS. The apparatus comprises a calling MT for encoding a session initiate protocol (SIP) invite message including multimedia alerting information and transmitting the encoded SIP invite message. A called MT for downloads multimedia information included in the SIP invite message from a multimedia alerting application server that maps previously stored multimedia information and its uniform resource locator (URL) to a header of the SIP invite message in association with an Internet protocol multimedia subsystem (IMS) server that receives the SIP invite message from the calling MT and transmits the SIP invite message to the called MT according to service profiles of the calling MT and the called MT, and plays back the downloaded multimedia information.

According to still another aspect of an exemplary embodiment of the present invention, there is provided a method for transmitting/receiving alerting information in a wireless communication system including a mobile terminal (MT), a base station (BS) connected to the MT through a wireless channel, and a packet data service node (PDSN) that provides a packet data service to the MT via the BS. The method comprises encoding a session initiate protocol (SIP) invite message including multimedia alerting information and transmitting the encoded SIP invite message. The SIP invite message is received from a calling MT and service profiles of the calling MT and a called MT is searched; The SIP invite message is transmitted to the called MT according to the search result to set up a call between the calling MT and the called MT. Encoded multimedia alerting information in the received SIP invite message is decoded and the multimedia alerting information is played back.

According to still another aspect of an exemplary embodiment of the present invention, there is provided a method for transmitting/receiving alerting information in a wireless communication system including a mobile terminal (MT), a base station (BS) connected to the MT through a wireless channel, and a packet data service node (PDSN) that provides a packet data service to the MT via the BS. The method comprises encoding, by a calling MT, a session initiate protocol (SIP) invite message including multimedia alerting information and transmitting the encoded SIP invite message. The SIP invite is received, by an Internet protocol multimedia subsystem (IMS) server, message from the calling MT and searching service profiles of the calling MT and a called MT. The SIP invite message is transmitted to the called MT according to the search result to set up a call between the calling MT and the called MT., Previously stored multimedia information and its uniform resource locator (URL) are mapped, by a multimedia alerting application server, to a header of the SIP invite message in association with the IMS server. Multimedia information included in the SIP invite message is downloaded and the downloaded multimedia information is played back.

According to a further aspect of an exemplary embodiment of the present invention, there is provided a method for transmitting/receiving alerting information in a wireless communication system including a mobile terminal (MT), a base station (BS) connected to the MT through a wireless channel, and a packet data service node (PDSN) that provides a packet data service to the MT via the BS. The method comprises encoding, by a calling MT, a session initiate protocol (SIP) invite message including multimedia alerting information and transmitting the encoded SIP invite message. Encoded multimedia alerting information included in the SIP invite message is received, by a called MT, from an Internet protocol multimedia subsystem (IMS) server that receives the SIP invite message from the calling MT and the SIP invite message is transmitted to the called MT according to service profiles of the calling MT and the called MT, the received encoded multimedia alerting information is decoded, and playing back the multimedia alerting information is played back.

According to yet another aspect of an exemplary embodiment of the present invention, there is provided a method for transmitting/receiving alerting information in a wireless communication system including a mobile terminal (MT), a base station (BS) connected to the MT through a wireless channel, and a packet data service node (PDSN) that provides a packet data service to the MT via the BS. The method comprises the steps of: encoding a session initiate protocol (SIP) invite message including multimedia alerting information and transmitting the encoded SIP invite message. Multimedia information included in the SIP invite message is downloaded from a multimedia alerting application server that maps previously stored multimedia information and its uniform resource locator (URL) to a header of the SIP invite message in association with an Internet protocol multimedia subsystem (IMS) server that receives the SIP invite message from the calling MT and the SIP invite message is transmitted to a called MT according to service profiles of the calling MT and the called MT, and the downloaded multimedia information is played back.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of certain exemplary embodiments of the present invention will be more apparent from the following description taken in conjunction with the accompanying drawings, in which:

FIG. 1 is a block diagram illustrating a configuration of a wireless communication system for transmitting/receiving alerting information for an MT according to an exemplary embodiment of the present invention;

FIG. 2 is a diagram illustrating a format of an SIP invite message used for transmitting alerting information for an MT according to an exemplary embodiment of the present invention;

FIG. 3 is a signaling diagram illustrating a method for transmitting/receiving alerting information for an MT in a wireless communication system according to an exemplary embodiment of the present invention; and

FIG. 4 is a signaling diagram illustrating a method for transmitting/receiving alerting information for an MT in a wireless communication system according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

According to an exemplary embodiment of the present invention, a calling MT transmits multimedia alerting information such as voice, picture, moving image and text information to a called MT using a Session Initiate Protocol (SIP) Invite message. The called MT is provided with the multimedia alerting information through the SIP Invite message.

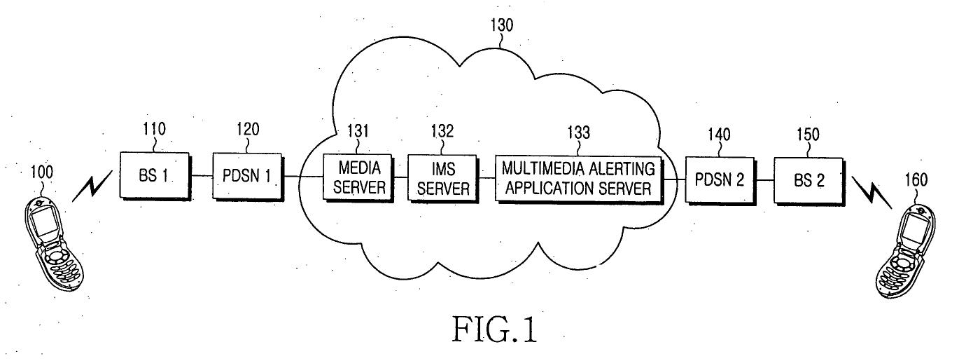

With reference to FIG. 1, a description will now be made of a wireless communication system for transmitting/receiving alerting information for an MT according to an exemplary embodiment of the present invention. As illustrated in FIG. 1, the wireless communication system for transmitting/receiving alerting information includes MTs 100 and 160, base stations (BSs) 110 and 150 connected to the MTs 100 and 160 via wireless channels, packet data service nodes (PDSNs) 120 and 140 for providing a packet data service to the MTs 100 and 160 via the BSs 110 and 150, and an alerting information transmission/reception system 130. The alerting information transmission/reception system 130 includes a media server 131, an IP multimedia subsystem (IMS) server 132, and a multimedia alerting application server 133.

The MTs 110 and 160 connected to each other via the alerting information transmission/reception system 130, PDSNs 120 and 140, and BSs 110 and 150, can all include wire terminals, wireless terminals, or wire/wireless integrated terminals. In the following description, an assumption will be made that the MT 100 serves as a calling MT and the MT 160 serves as a called MT. For example, the MTs 100 and 160 may be designed so they can record and playback multimedia alerting information such as voice, picture, moving image and text information that is personally input by users. The MTs 100 and 160 have processing power enough to enable the recording and playback operations for the multimedia alerting information. In addition, the MTs 100 and 160 can transmit/receive and playback multimedia alerting information through a header of an SIP Invite message. Also, the MTs 100 and 160 can perform authentication on a uniform resource locator (URL) received through a header of an SIP Invite message, that is, an address of multimedia alerting information stored in the multimedia alerting application server 133, and can be provided with multimedia alerting information from the multimedia alerting application server 133.

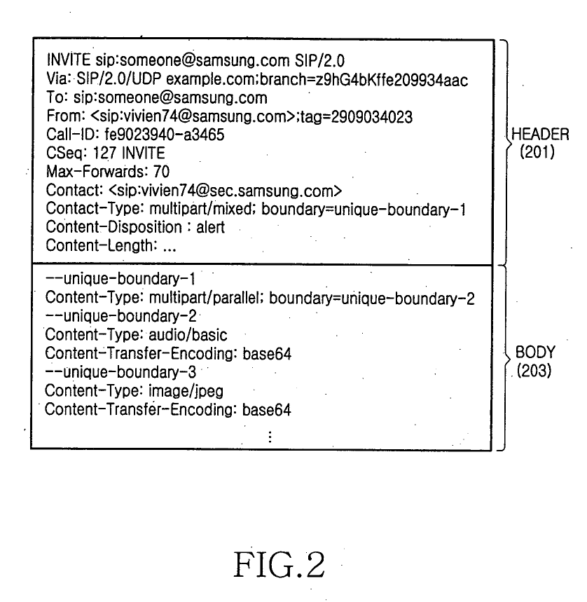

With reference to FIG. 2, a description will now be made of a format of the SIP Invite message. As illustrated in FIG. 2, the SIP Invite message can include a header 201 and a body 203. The SIP Invite message can include multimedia alerting information such as voice, picture, moving image and text information. The actual multimedia alerting information is included in the body 203 of the SIP Invite message.

In describing the SIP Invite message, “Content-Type: multipart/mixed; boundary=unique-boundary-1” defines “Content-Type Header” in a multipart type such that “Content-Type Header” can transmit one or more content types of multimedia information, and inserts a content type in the body 203 in which a boundary identifier is defined as “unique-boundary-1.”

“Content-Disposition: alert” sets a type of “Content-Disposition Header” as alerting information so that corresponding content is provided as a bell when a called MT receives the message.

Inserted in the body 203 of the SIP Invite message is “single-channel mu-law-format audio data” of 8000 Hz encoded in a base 64 form. That is, a voice recorded by a sender is defined in the form of “Content-Type: audio/basic” and then encoded in the body 203 before being transmitted.

In addition, the body 203 of the SIP Invite message has image data encoded in the base 64 form, which is inserted in the form of “Content-Type: image/jpeg”. In addition to the voice of the sender, a picture of the sender can also be transmitted after being encoded.

The media server 131 stores voice and a moving image of the sender, which is recorded (or input) by button manipulation of the sender before the calling MT 100 attempts a call.

The IMS server 132 manages a call setup and release between the calling MT 100 and the called MT 160. The IMS server 132 sets up a session for an IP multimedia subscriber, which provides an alerting information service, and transmits to the called MT 160 a message received from the alerting application server 133 in association with the multimedia alerting application server 133. The IMS server 132 transmits the message at a time when there is a need to provide particular alerting information to the called MT 160 according to a service profile of the sender.

The multimedia alerting application server 133 provides the IMS server 132 with corresponding multimedia alerting information according to a service profile of each individual subscriber, and provides a multimedia information storage function through the web site. In addition, the multimedia alerting application server 133 has multimedia information recorded by and uploaded from the calling MT 100, combines several types of multimedia information (voice, picture, moving image and text information), and provides the combined multimedia information to the called MT 160. The multimedia alerting application server 133 provides the called MT 160 with a function capable of denying alerting information of the sender, if the function is defined in the service profile. The multimedia alerting application also provides the called MT 160 with a function capable of choosing denial of receiving the alerting information according to the sender type who provides the alerting information. Further, the multimedia alerting application server 133 provides the calling MT 100 with a function capable of choosing denial of sending alerting information, if the function is defined in the service profile.

The calling MT 100 provides the sender with a multimedia information recording function, and stores in a directory the multimedia alerting information downloaded from the multimedia alerting application server 133. The calling MT 100 has a function of setting/releasing a function of transmitting its multimedia information stored in the multimedia alerting application server 133 to the called MT 160 using a menu key when sending a call, and also has a function of playing back the multimedia information included in the SIP Invite message.

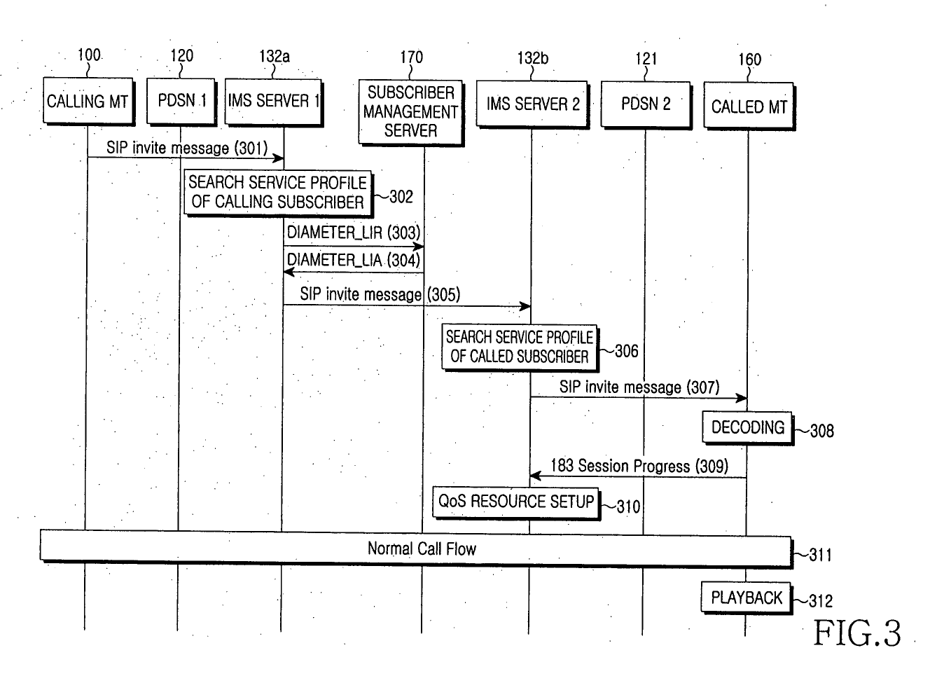

With reference to FIG. 3, a description will now be made of a method for transmitting/receiving alerting information in a wireless communication system according to an exemplary embodiment of the present invention.

A sender, before making a call attempt using a calling MT 100, records his/her voice and a moving image by pressing a particular button, for example, a “Multimedia Alerting Information” button, prepared on the calling MT 100. After the recording, the sender attempts a call by inputting a phone number of a recipient.

After the call attempt, the sender can store the recorded voice and moving image in the calling MT 100. The sender can also record, in the calling MT 100, the multimedia information such as bell sound, voice and moving image, for each individual recipient stored in a directory. In addition, the calling MT 100 can download corresponding multimedia information from the multimedia alerting application server 133 or the media server 131.

The calling MT 100, during the call attempt, transmits the recorded multimedia information to an IMS server #1 132a with an SIP Invite message in step 301. The SIP Invite message is transmitted in the form of “Content-Type: multipart/mixed or audio/basic, content-Disposition alert,” as shown in FIG. 2. The IMS server #1 132a searches service profile information of a subscriber of the calling MT 100 in step 302. The IMS server #1 132a searches the service profile information of the subscriber to determine whether a corresponding subscriber is a registered subscriber capable of receiving a multimedia alerting service. If the corresponding subscriber is a registered subscriber capable of receiving the multimedia alerting service, the IMS server #1 132a sends a request for subscriber information of a called MT 160 to a subscriber management server 170 in step 303 to search an IMS server #2 132b for the called MT 160 in order to perform the multimedia alerting service. Consequently, the IMS server #1 132a transmits a Location Information Request (DIAMETER_LIR) message to the subscriber management server 170. In response, the subscriber management server 170 extracts subscriber information of the called MT 160 because the subscriber management server 170 has subscriber and location information, and an authentication function for MTs. The subscriber management server 170 then transmits a Location Information Answer (DIAMETER_LIA) message, including the extracted subscriber information of the called MT 160, to the IMS server #1 132a in step 304. Then the IMS server #1 132a transmits in step 305 an SIP Invite message, including multimedia alerting information, to the IMS server #2 132b for the called MT 160 searched through the subscriber information included in the DIAMETER_LIA message. The IMS server #2 132b searches a service profile of the called subscriber in step 306 to determine whether the called MT 160 can receive the SIP Invite message. If the called MT 160 can receive the SIP Invite message, that is, if the called MT 160 can receive the multimedia alerting service, the IMS server #2 132b transmits the SIP Invite message to the called MT 160 in step 307. The called MT 160 decodes multimedia information included in a header and a body of the received SIP Invite message in step 308. The called MT 160 transmits a 183 Session Progress message to the IMS server #2 132b in step 309, and the IMS server #2 132b sets up Quality-of Service (QoS) resource in step 310. The called MT 160 performs a normal call flow with the calling MT 100 in step 311, and plays back the multimedia information included in the SIP Invite message in step 312.

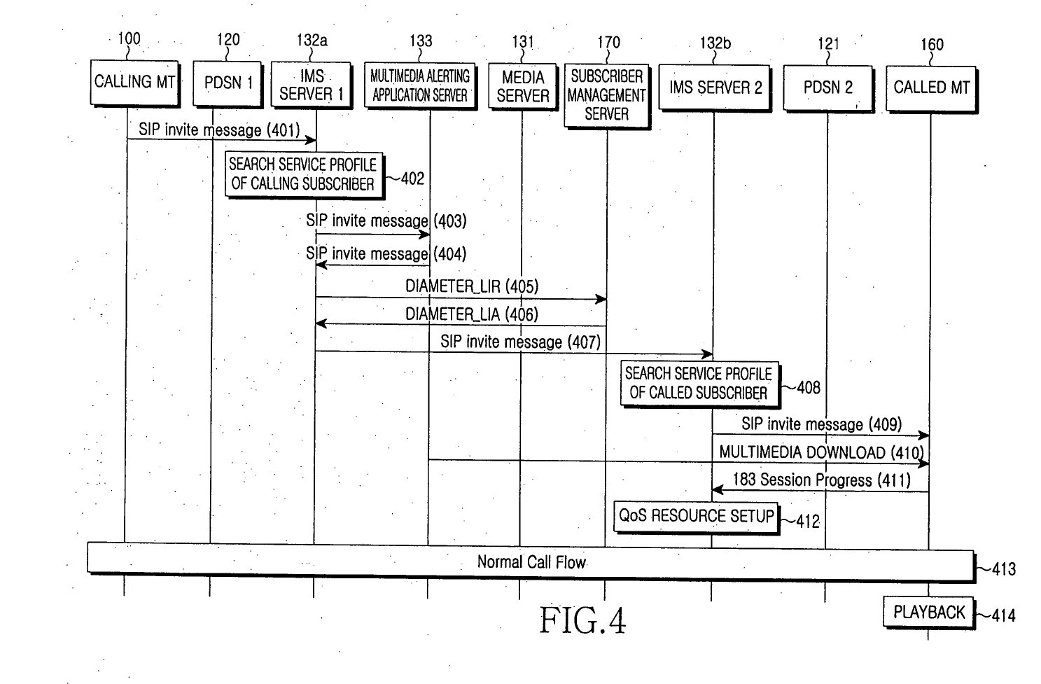

With reference to FIG. 4, a description will now be made of a method for transmitting/receiving alerting information in a wireless communication system according to an exemplary embodiment of the present invention.

A calling MT 100 transmits an SIP Invite message for requesting transmission of alerting information to an IMS server #1 132a in step 401, if a particular button for the multimedia alerting service is selected before it makes a call attempt. For example, the SIP Invite message may include “Alert-Info: <http://www.example.com/sounds/multimediabell.wav>” in its header. The SIP Invite message is transmitted with a corresponding multimedia URL designated in its “Alert-Info Header.”

The IMS server #1 132a searches service profile information of a subscriber of the calling MT 100 in step 402, to determine whether a corresponding subscriber is a registered subscriber capable of receiving the multimedia alerting service. If the corresponding subscriber is a registered subscriber capable of receiving the multimedia alerting service, the IMS server #1 132a transmits an SIP Invite message to an alerting application server 133 in step 403. For example, the IMS server #1 132a interworks with the multimedia alerting application server 133 after searching the service profile of the calling subscriber. In response, the multimedia alerting application server 133 transmits an SIP Invite request message to the IMS server #1 132a in step 404. That is, the multimedia alerting application server 133 maps the corresponding multimedia information and its URL to an Alert-Info header of the SIP Invite message according to a preference of the sender, and transmits the mapping result to the IMS server #1 132a. The multimedia alerting application server 133, depending on its capability, can either provide multimedia information to a called MT 160 in association with a media server 131, or provide two or more types of multimedia information (picture, text, moving image, avatar, and the like) to the called MT 160 directly.

The IMS server #1 132a transmits a DIAMETER_LIR message for requesting subscriber information of the called MT 160 to a subscriber management server 170 in step 405 to search an IMS server associated with the called MT 160. Then the subscriber management server 170 transmits a DIAMETER_LIA message including subscriber information of the called MT 160 to the IMS server #1 132a in step 406, because the subscriber management server 170 has subscriber information, location information and an authentication function for MTs. The IMS server #1 132a transmits an SIP Invite message including multimedia alerting information to an IMS server #2 132b associated with the called MT 160 included in the DIAMETER_LIA message in step 407.

The IMS server #2 132b searches a service profile of the called subscriber in step 408 to determine whether the called MT 160 can receive the SIP Invite message. If the called MT 160 can receive the SIP Invite message, that is, if the called MT 160 can receive the multimedia alerting service, the IMS server #2 132b transmits an SIP Invite message to the called MT 160 in step 409. Then the called MT 160 downloads, in step 410, multimedia alerting information from the multimedia alerting application server 133, depending on a URL included in a header of the received SIP Invite message using a Hyper Text Transfer Protocol (HTTP), and then holds the downloaded multimedia alerting information for a while until a QoS setup between the calling MT 100 and the called MT 160 is completed. That is, the called MT 160 checks an Alert-Info header of the received SIP Invite message, and then downloads corresponding multimedia information from the multimedia alerting application server 130 using the HTTP. Thereafter, the called MT 160 transmits a 183 Session Progress message to the IMS server #2 132b in step 411, and the IMS server #2 132b sets up QoS resource in step 412.

If the QoS resource setup between the calling MT 100 and the called MT 160 is completed, a normal call flow is performed in step 413. Thereafter, in step 414, the called MT 160 plays back the multimedia information downloaded in step 410 using the HTTP.

As can be understood from the foregoing description, exemplary embodiments of the present invention can transmit alerting information based on intention, preference and taste of the sender. In addition, exemplary embodiments of the present invention can provide a function capable of transmitting sender-specific alerting information associated with a particular event such as a wedding anniversary and a birthday, informing the called party of the caller's identity.

While the invention has been shown and described with reference to a certain exemplary embodiments thereof, it will be understood by those skilled in the art that various changes in form and details may be made therein without departing from the spirit and scope of the invention as defined by the appended claims.

What is claimed is:

1. A system for transmitting and receiving alerting information in a wireless communication system comprising a mobile terminal (MT), a base station (BS) connected to the MT through a wireless channel, and a packet data service node (PDSN) that provides a packet data service to the MT via the BS, the system comprising:
a calling MT for encoding a session initiate protocol (SIP) invite message comprising multimedia alerting information and transmitting the encoded SIP invite message;
an Internet protocol multimedia subsystem (IMS) server for receiving the SIP invite message from the calling MT; and
a called MT for decoding encoded multimedia alerting information in the received SIP invite message and playing back the multimedia alerting information,
wherein the IMS server transmits the SIP invite message to a called MT according to service profiles of the calling MT and the called MT.

2. The system of claim 1, wherein the SIP invite message comprises a header comprising a content type indicating at least one type of possible multimedia information and a body having actual multimedia alerting information corresponding to the content type.

3. The system of claim 2, wherein the multimedia information comprises voice, picture, moving image and text information.

4. The system of claim 1, further comprising a media server for providing a multimedia content to the calling MT.

5. A system for transmitting and receiving alerting information in a wireless communication system comprising a mobile terminal (MT), a base station (BS) connected to the MT through a wireless channel, and a packet data service node (PDSN) that provides a packet data service to the MT via the BS, the system comprising:
a calling MT for encoding a session initiate protocol (SIP) invite message comprising multimedia alerting information and transmitting the encoded SIP invite message;
an Internet protocol multimedia subsystem (IMS) server for receiving the SIP invite message from the calling MT, searching service profiles of the calling MT and a called MT, and transmitting the SIP invite message to the called MT according to the search result in order to set up a call between the calling MT and the called MT; and
a multimedia alerting application server for mapping previously stored multimedia information and an uniform resource locator (URL) of the previously multimedia information to a header of the SIP invite message in association with the IMS server, and uploading the multimedia information to the called MT,
wherein the called MT downloads multimedia information in the SIP invite message from the multimedia alerting application server, and plays back the downloaded multimedia information.

6. The system of claim 5, wherein the header of the SIP invite message comprises a designated multimedia URL.

7. The system of claim 5, wherein the previously stored multimedia information and the URL of the previously stored multimedia information comprises information based on intention, preference and taste of a sender.

8. The system of claim 5, wherein the multimedia alerting application server stores the multimedia information through a web site.

9. An apparatus for transmitting and receiving alerting information in a wireless communication system comprising a mobile terminal (MT), a base station (BS) connected to the MT through a wireless channel, and a packet data service node (PDSN) that provides a packet data service to the MT via the BS, the apparatus comprising:
a calling MT for encoding a session initiate protocol (SIP) invite message comprising multimedia alerting information and transmitting the encoded SIP invite message; and
a called MT for receiving the SIP invite message from an Internet protocol multimedia subsystem (IMS) server that receives the SIP invite message from the calling MT and transmits the SIP invite message to the called MT according to service profiles of the calling MT and the called MT, decoding encoded multimedia alerting information in the received SIP invite message, and playing back the multimedia alerting information.

10. The apparatus of claim 9, wherein the SIP invite message comprises a header comprising a content type indicating at least one type of possible multimedia information and a body having actual multimedia alerting information corresponding to the content type.

11. The apparatus of claim 10, wherein the multimedia information comprises voice, picture, moving image and text information.

12. An apparatus for transmitting/receiving alerting information in a wireless communication system comprising a mobile terminal (MT), a base station (BS) connected to the MT through a wireless channel, and a packet data service node (PDSN) that provides a packet data service to the MT via the BS, the apparatus comprising:
a calling MT for encoding a session initiate protocol (SIP) invite message comprising multimedia alerting information and transmitting the encoded SIP invite message; and
a called MT for downloading multimedia information in the SIP invite message from a multimedia alerting application server that maps previously stored multimedia information and an uniform resource locator (URL) of the previously stored multimedia information to a header of the SIP invite message in association with an Internet protocol multimedia subsystem (IMS) server that receives the SIP invite message from the calling MT and transmits the SIP invite message to the called MT according to service profiles of the calling MT and the called MT, and playing back the downloaded multimedia information.

13. The apparatus of claim 12, wherein the header of the SIP invite message comprises a designated multimedia URL.

14. The apparatus of claim 12, wherein the previously stored multimedia information and the URL of the previously stored multimedia information comprises information based on intention, preference and taste of a sender.

15. A method for transmitting and receiving alerting information in a wireless communication system comprising a mobile terminal (MT), a base station (BS) connected to the MT through a wireless channel, and a packet data service node (PDSN) that provides a packet data service to the MT via the BS, the method comprising the steps of:
encoding a session initiate protocol (SIP) invite message comprising multimedia alerting information and transmitting the encoded SIP invite message;
receiving the SIP invite message from a calling MT and searching service profiles of the calling MT and a called MT;
transmitting the SIP invite message to the called MT according to a search result in order to set up a call between the calling MT and the called MT; and
decoding encoded multimedia alerting information in the received SIP invite message and playing back the multimedia alerting information.

16. The method of claim 15, wherein the SIP invite message comprises a header comprising a content type indicating at least one type of possible multimedia information and a body having actual multimedia alerting information corresponding to the content type.

17. The method of claim 16, wherein the multimedia information comprises voice, picture, moving image and text information.

18. A method for transmitting and receiving alerting information in a wireless communication system comprising a mobile terminal (MT), a base station (BS) connected to the MT through a wireless channel, and a packet data service node (PDSN) that provides a packet data service to the MT via the BS, the method comprising the steps of:
encoding, by a calling MT, a session initiate protocol (SIP) invite message comprising multimedia alerting information and transmitting the encoded SIP invite message;
receiving, by an Internet protocol multimedia subsystem (IMS) server, the SIP invite message from the calling MT and searching service profiles of the calling MT and a called MT;
transmitting the SIP invite message to the called MT according to a search result to set up a call between the calling MT and the called MT;
mapping, by a multimedia alerting application server, previously stored multimedia information and an uniform resource locator (URL) of the previously stored multimedia information to a header of the SIP invite message in association with the IMS server; and
downloading multimedia information in the SIP invite message and playing back the downloaded multimedia information.

19. The method of claim 18, wherein the header of the SIP invite message comprises a designated multimedia URL.

20. The method of claim 18, wherein the previously stored multimedia information and the URL of the previously stored multimedia information comprises information based on intention, preference and taste of a sender.

21. A method for transmitting and receiving alerting information in a wireless communication system comprising a mobile terminal (MT), a base station (BS) connected to the MT through a wireless channel, and a packet data service node (PDSN) that provides a packet data service to the MT via the BS, the method comprising the steps of:
encoding, by a calling MT, a session initiate protocol (SIP) invite message comprising multimedia alerting information and transmitting the encoded SIP invite message; and
receiving, by a called MT, encoded multimedia alerting information in the SIP invite message from an Internet protocol multimedia subsystem (IMS) server that receives the SIP invite message from the calling MT and transmits the SIP invite message to the called MT according to service profiles of the calling MT and the called MT, decoding the received encoded multimedia alerting information, and playing back the multimedia alerting information.

22. The method of claim 21, wherein the SIP invite message comprises a header comprising a content type indicating at least one type of possible multimedia information and a body having actual multimedia alerting information corresponding to the content type.

23. The method of claim 21, wherein the multimedia information comprises voice, picture, moving image and text information.

24. A method for transmitting and receiving alerting information in a wireless communication system comprising a mobile terminal (MT), a base station (BS) connected to the MT through a wireless channel, and a packet data service node (PDSN) that provides a packet data service to the MT via the BS, the method comprising the steps of:
encoding a session initiate protocol (SIP) invite message comprising multimedia alerting information and transmitting the encoded SIP invite message; and
downloading multimedia information in the SIP invite message from a multimedia alerting application server that maps previously stored multimedia information and an uniform resource locator (URL) of the previously stored multimedia information to a header of the SIP invite message in association with an Internet protocol multimedia subsystem (IMS) server that receives the SIP invite message from the calling MT and transmits the SIP invite message to a called MT according to service profiles of the calling MT and the called MT, and playing back the downloaded multimedia information.

25. The method of claim 24, wherein the header of the SIP invite message comprises a designated multimedia URL.

26. The method of claim 24, wherein the previously stored multimedia information and the URL of the previously stored multimedia information comprises information based on intention, preference and taste of a sender.
